(19) United States
(12) Patent Application Publication
(10) Pub. No.: US 2014/0245438 A1
(43) Pub. Date: Aug. 28, 2014

(54) DOWNLOAD RESOURCE PROVIDING METHOD AND DEVICE

(71) Applicant: BEIJING QIHOO TECHNOLOGY COMPANY LIMITED, Beijing (CN)

(72) Inventors: Ningyi Chen, Beijing (CN); Yipeng Zhu, Beijing (CN)

(21) Appl. No.: 14/347,491

(22) PCT Filed: Sep. 19, 2012
(86) PCT No.: PCT/CN2012/081616

§ 371 Date: Mar. 26, 2014

(30) Foreign Application Priority Data
Sep. 28, 2011 (CN) 201110301270.2

(51) Int. Cl. H04L 29/06; G06F 17/30; G06F 17/22

(52) U.S. Cl. CPC H04L 63/1408; G06F 17/2235; G06F 17/30864
USPC 726/22

(57) ABSTRACT

Disclosed are download resource providing method and device, wherein the method comprises: detecting security of an original resource to be downloaded by a user; if the original resource is detected to be insecure, querying a secure download resource matching the user's download requirement; and providing the user with link information of the secure download resource. The technical solution of the present invention ensures that the provided alternative resource is secure, meanwhile avoids consumption of the system resource and network bandwidth due to repeated searching and downloading operations of the user.

### FIELD OF THE INVENTION

The present invention relates to the technical field of Internet application, and particularly to a download resource providing method and device.

### BACKGROUND OF THE INVENTION

Along with development of the Internet, more and more users are used to searching and downloading resources of their interest from the Internet. However, while providing convenience for the users, the Internet also provides a propagation environment for malicious programs such as computer virus and Trojan virus. Producers or propagators of malicious programs often disguise the malicious programs as other resources, or hide and entrain the malicious programs in other resource packets. If other users download such resources into the computer, the computer is very easily infected by virus or Trojan so as to result in various undesirable consequences.

In order to improve security of a computer system, a majority of users choose to install anti-virus software in the computer. The anti-virus software generally has a real-time monitoring function and can perform security detection for the data to be written into the local computer. If the data are determined to be virus or Trojan, the data will be removed from the local computer.

The real-time monitoring function of current anti-virus software may effectively prevent malicious programs in the network from entering and staying in the local computer and thereby improve security of the system. However, upon completion of checking and killing of virus or Trojan, it is still probable that the user still has not obtained the resource he desires and he needs to re-search in the network, and even if new download resource is found, its security still cannot be guaranteed. Repetition of this procedure causes waste of the user's efforts and time and ineffective occupation of the system resource and network bandwidth.

### SUMMARY OF THE INVENTION

In view of the above technical problems, the present invention is proposed to provide a download resource providing method and device, which can overcome the above problems or at least partially solve or ease the above problems, and which can, after detecting that original content to be downloaded by the user is insecure, automatically search for alternative resource for the original content to be downloaded and provide it to the user. The technical solution is as follows.

According to an aspect of the present invention, there is provided a method for providing download resource comprising: detecting security of an original resource to be downloaded by a user; if the original resource is detected to be insecure, querying a secure download resource matching the user's download requirement; and providing the user with link information of the secure download resource.

According to another aspect of the present invention, there is provided a device for providing download resource comprising: a security detecting unit configured to detect security of an original resource to be downloaded by a user; a download resource querying unit configured to query a secure download resource matching the user's download requirement in the case that a detection result of the security detecting unit is insecure; and a download resource providing unit configured to provide the user with link information of the secure download resource.

According to a further aspect of the present invention, there is provided a computer program which comprises a computer readable code, wherein when the computer readable code is run on a server, the server executes the method for providing download resource according to any one of claims 1-9.

According to a further aspect of the present invention, there is provided a computer readable medium which stores the computer program according to claim 19.

According to the technical solution provided by the present invention, after the resource already downloaded or to be downloaded by the user is detected insecure, an alternative resource meeting the user's download requirement is sought for according to the user's actual download requirement, and directly provided to the user. The user is not required to manually seek for a new download resource again. Meanwhile, security of the provided alternative resource is guaranteed, and the user may directly use them after downloading, whereby convenience is provided for the user, and consumption of system resource and network bandwidth caused by the user's repeated search and download is also avoided.

The above description is only generalization of technical solutions of the present invention. The present invention may be implemented according to the content of the description in order to make technical means of the present invention more apparent. Specific embodiments of the present invention are exemplified to make the above and other objects, features and advantages of the present invention more apparent.

### BRIEF DESCRIPTION OF DRAWINGS

Various other advantages and merits will become apparent to those having ordinary skill in the art by reading through the following detailed description of preferred embodiments. Figures are only intended to illustrate preferred embodiments not to limit the present invention. In all figures, the same reference number denotes the same part. In the figures:

FIG. 1 illustrates a flow chart of a method for providing download resource according to the present invention;

FIG. 2 illustrates a flow chart of a method of detecting security of download resource according to the present invention;

FIG. 3 illustrates a structural schematic view of a device for providing download resource according to the present invention;

FIG. 4 illustrates a structural schematic view of a download resource querying unit according to the present invention;

FIG. 5 illustrates the second kind of structural schematic view of a download resource querying unit according to the present invention;

FIG. 6 illustrates the third kind of structural schematic view of a download resource querying unit according to the present invention;

FIG. 7 illustrates a structural schematic view of a security detecting unit according to the present invention;

FIG. 8 illustrates a block diagram of a server for executing the method according to the present invention; and

FIG. 9 illustrates a memory unit for maintaining or carrying a program code for implementing the method according to the present invention.

### DETAILED DESCRIPTION OF PREFERRED EMBODIMENTS

The present invention will be further described below with reference to figures and specific embodiments.

First, description is given to a method for providing download resource according to an embodiment of the present invention. The method may comprise the following steps:
detecting security of an original resource to be downloaded by a user;
if the original resource is detected to be insecure, querying a secure download resource matching the user's download requirement; and
providing the user with link information of the secure download resource.

In the above solution, firstly the security of an original resource to be downloaded by a user is detected, wherein the detecting step may be performed either before the user executes the download operation or after the user finishes the downloading. If the original resource to be downloaded by the user is detected to be insecure, based on the user's actual download requirement, an alternative resource for meeting the user's download requirement is further sought for and then directly provided to the user. The user's download requirement may be directly obtained according to the user's manual input, or recognized automatically according to the download link of the original resource.

According to the technical solution provided by the present invention, after the resource already downloaded or to be downloaded by the user is detected insecure, it is not necessary for the user to manually seek for a new download resource again, whereby the user's operation is simplified and convenience is provided to the user. Meanwhile, security of the provided alternative resource is guaranteed, for example, by providing a link of an official website of software or providing a link in a resource repository already subjected to security verification. After downloading these resources, the user may directly use them, which avoids consumption of system resource and network bandwidth caused by the user's repeated search and download.

In order to enable those skilled in the art to understand technical solutions of the present invention better, the technical solutions in the present invention will be described in detail with reference to the figures. Obviously, the described embodiments are only partial embodiments of the present invention, not all embodiments. All other embodiments obtained by those having ordinary skill in the art based on embodiments in the present invention shall fall within the protection scope of the present invention.

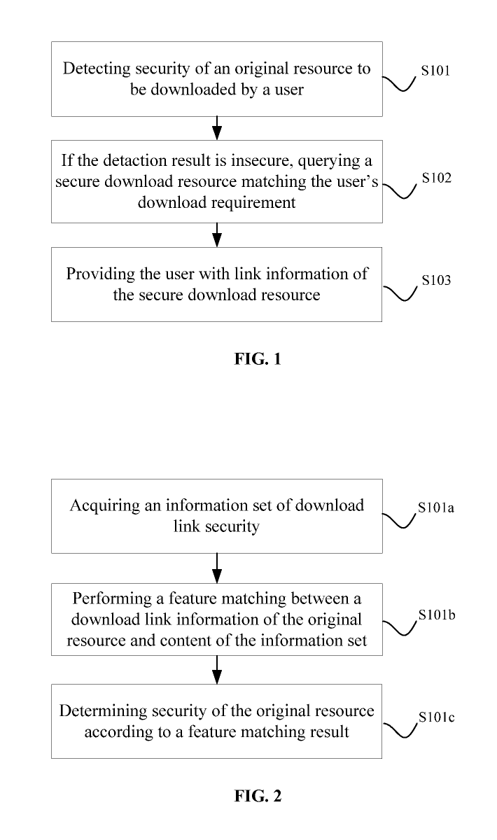

FIG. 1 illustrates a flow chart of a method of providing download resource according to the present invention, comprising the following steps.

Step S101: detecting the security of an original resource to be downloaded by a user.

According to a solution in the prior art, security detection may be performed for the data to be written into the local computer. For example, after the user confirms the download operation, the data are first transmitted via a network from a data source to the user's local computer, and the local computer may perform feature matching between the downloaded data and feature codes of a virus database or Trojan database so as to determine whether the downloaded data are secure. It is also feasible to divide, from a memory or hard disk of the local computer, a space isolated from the system, execute the download program in the isolated space, and determine whether the downloaded program is secure according to an execution result.

It may be appreciated that the security detection of the download resource may also be implemented in many specific solutions, which needn't be limited here in the present invention.

Step S102: if the original resource is detected to be insecure, querying a secure download resource matching the download requirement of the user;

According to a solution in the prior art, if the data downloaded by the user is detected to be insecure, the system will send a warning to the user, and furthermore, may remove the data from the local computer to ensure the system secure. However, although security is guaranteed, the user does not obtain the download resource he really wants. Regarding this issue, in the solution provided by the present invention, if the resource to be downloaded by the user is detected insecure, help will be provided to the user to search for the user-wanted resource.

To have a targeted search for the resource, first the actual download requirement of the user need to be acquired. A basic implementation solution is: after the download resource is detected insecure, a warning prompt is sent to the user and an input interface is provided to the user to request the user to input his own download requirement, and then secure download resource is searched for according the content input by the user. For example, if the user wants to download “angry bird” and the content downloaded by him for the first time is detected to include virus, an input interface may be provided to the user at this time; after the user inputs “angry bird”, the download resource related to secure “angry bird” may be searched for according to the content input by the user.

The above solution about how to obtain the user's actual download requirement is equivalent to directly sending a query to the user, which is advantageous in excellent accuracy. However, this requires the user's manual operation, which brings inconvenience to the user to some extent. Regarding this issue, another solution about obtaining the user's actual download requirement provided by the present invention is: obtaining the user's download requirement information according to the user's history of search behaviors.

When the user needs to download a resource, a common operation is first to input a search key word in a search engine, and then access a search webpage according to search results. The search key word may represent the user's download requirement very well. Therefore, the user's download requirement information may be automatically obtained by extracting the search key word used by the user for the last time, so as to reduce the user's repeated input operations.

The present invention further provides a manner of automatically recognizing the user's download requirement according to the download link information of the original resource. This is specifically implemented as follows.

Each resource downloaded from the network has corresponding download link information. The user's download requirement may be estimated from multiple angles based on the download link information. Examples are as follows.

A file name of the original resource may be obtained by parsing the download link information of the original resource. As for some network resources, their file names per se may effectively identify the resources themselves. Hence, in many cases, the file name of the download resource may directly represent the user's download requirement.

In many download websites, an individual webpage will be provided for each download resource. Titles of these webpages may describe the download resource well. In some cases, an original webpage where the download resource lies may be positioned by parsing the download link information of the original resource, and further a source code of the webpage may be obtained. The title of the webpage may be obtained by obtaining content of a “title” field in the webpage source code, and the content of the title is probably the user's download requirement.

Besides, after the original webpage where the download resource lies is positioned, the presented webpage text information corresponding to the original resource may be further found by parsing the webpage source code. In some cases, such information might also represent the user's download requirement.

The above provides three solutions of automatically recognizing the user's download requirement. In practice, the three solutions may be used individually or in combination, for example, when the recognition results obtained by said solutions are coincident, it is believed that the recognition result is usable.

In one embodiment of the present invention, it is feasible to present an automatic recognition result to the user and request the user to confirm the recognition result so as to ensure accuracy of the recognition. Here, multiple recognition results may be simultaneously presented to the user; if the user believes that one of the automatic recognition results is coincident with his idea, he may directly confirm the recognition result and submit it as his own download requirement information.

It may be appreciated that the user's manual input of download requirement may be implemented in combination with automatic recognition of the download requirement. For example, the user's download requirement is recognized first, and the recognition result is presented to the user, and meanwhile an input interface is provided to the user. If the user believes that the automatic recognition result is coincident with his own idea, he may directly confirm the recognition result; and if the user believes that the automatic recognition result is not coincident with his own idea, the download requirement information is then input manually.

Furthermore, it should be ensured that the new download resource found for the user is secure. In order to guarantee security of the query result, it is possible to execute the query operation in a network scope that can guarantee resource security, for example, an official website of software or a safeguarded download site. Certainly, resource link information corresponding to hot download requirements for users may be pre-collected and a database may be built. The corresponding link information is directly acquired from the database after the user's download requirement is determined. If the storage resource allows, a resource repository may be built on its own, the resource having passed the security detection is directly stored the resource repository, and corresponding download link information is directly acquired from the resource repository after the user's download requirement is determined.

Step S103: providing the user with link information of the secure download resource.

In the step, the link information of the found secure download resource is provided to the user according to the query result in step S102, to facilitate the user's download again. Those skilled in the art may understand that the link information provided to the user in this step may be one or more depending on different secure resource lookup manners in step S102.

The method provided by the above embodiment involves detecting security of a resource after the user downloads the resource to the local computer. In another embodiment of the present invention, security of the download link can be detected before the user performs the downloading, thereby reducing the user's ineffective download behavior and further reducing consumption of the network bandwidth resource.

FIG. 2 illustrates a flow chart of a method of detecting security of download resource according to the present invention, corresponding to step S101. The step may specifically further comprise the following sub-steps.

Sub-step S101a: acquiring an information set of download link security.

According to the solution provided by the present invention, firstly it is necessary to have an information set capable of identifying download link security in order to detect the security of the download link. The information set may be carried in many specific modes, for example, in the form of a list or a text. To facilitate description, a “list” will be taken in place of an “information set” in the present embodiment.

In this list of download link security are recorded URLs of several download links and also recorded whether the corresponding resource of each of the URLs is secure. In practical application, the list may be in a form of black list or white list or a mixed form of black list and white list, wherein the black list indicates a set of unsecure download links while the white list indicates a set of secure downlink links.

The content of the list of download link security may be obtained according to a certain amount of testing statistics, and may be updated and improved constantly. Each URL in the list may be a specific download resource address, which is adapted for such a situation that the security of a certain specific link is already confirmed; and it may also be the domain name of a certain website or a website path, which is adapted for such a situation that overall security of the website is already confirmed. For example, the security of software as download resources provided by some official websites is guaranteed, and such websites may be recorded in the form of a website white list; download resources provided by some websites often carry virus or Trojan, and such websites may be recorded in the form of a website black list.

Sub-step S101b: performing feature matching between the download link information of the original resource and the content of the information set.

Sub-step S101c: determining security of the original resource according to a feature matching result.

The most common download behavior of a user during surfing the Internet is to find a download link in a browsed webpage, and then perform a downloading by directly clicking the download link in the webpage or by using a download software. For such a download behavior, the solution provided in an embodiment of the present invention is to trigger the sub-step S101b while the user is browsing the webpage. The solution is specifically as follows.

When the user is browsing the webpage, the information of the download link in the current webpage is extracted. This step may be implemented by acquiring a source code of the webpage and extracting from the source code a portion having features as download links. Furthermore, feature matching is performed between the extracted download link information and the content of the list of download link security. If the extracted download link information is successfully matched with the white-list portion in the list, it is believed that the extracted download link is secure. If the extracted download link information is successfully matched with the black-list portion in the list, it is believed that the extracted download link is unsecure. Alternatively, if the extracted download link information is not successfully matched with the white list in the list, it is believed that the extracted download link is insecure

In another embodiment of the present invention, the sub-step S101b may be triggered when the user executes a download operation, as described in detail as follows.

When the user triggers the download operation, feature matching will be performed between the download link information and the content of the list. The user's download operation may comprise: directly clicking the download link in the webpage, using a downloading tool to download the download link, inputting a download address into a browser address bar or a downloading tool, or the like. According to the solutions of embodiments of the present invention, after the user's download behavior is detected, the feature matching begins to be performed between the download link information and the content of the list of download link security; and before the user confirms the download operation, the detection result of security of the download link is given.

The solution of detecting security of the download link provided by the embodiment of the present invention may be implemented in a client used by the user, e.g., built in software such as anti-virus software, Internet-surfing protective software and browser software. After the client software is installed initially, a basic list of download link security may exist locally in the client. As security of download links in the list might change at any time and the amount of resource in the network is huge, the content of the list may be enriched and improved constantly by testing. In an embodiment of the solution of the present invention, a server may be provided at a network side to store the latest list of download link security, the client may download the list of download link security as it initial list or constantly update the list of download link security by connecting to the server. An updating mode may be manual triggering by users, periodical triggering, or voluntary pushing by the server, similar to an update mechanism of an anti-virus database of the anti-virus software.

By means of the technical solution provided by the embodiment, statistics regarding security of download links in a network are collected in advance to generate an information set, and whether a download link in the webpage is secure is determined according to the preset information set, so that the user can know the security of the download link before downloading data, and further seek for secure download link. As compared with the manner of performing security detection after the downloading, this manner further decreases the user's ineffective download behaviors and reduces the consumption of network bandwidth resources.

In an embodiment according to the present invention, a network side server may also generate the list of download link security according to detection results reported by other clients. The specific method is as follows.

Since many users choose to install anti-virus software in their computers, the real-time monitoring function of these anti-virus softwares can detect data that have just been downloaded to the local computer and determines whether the downloaded data can be written into the local computer safely according to the detection results. In the embodiment of the present invention, the client installed with the anti-virus software, after finishing detection for the downloaded data, reports the detection results (i.e. secure or not) along with the address of the download link to the network server. In this way, the server can quickly collect a lot of detection results and more efficiently enrich and improve the content of the list of download link security.

According to actual needs, the client installed with the anti-virus software may only report the detected unsecure download links to the network side server, or may report all detection results to the network side server, which is not limited by the present invention.

The solution of the present embodiment makes full use of the characteristic that there are a large number of Internet users, diverts the testing task, which should originally be completed by a system side, to individual users on the Internet. As such, without increasing human costs on the system side, the content of the list of download link security is updated constantly, and client may obtain the updated download link security list timely from the server side, and the capability of detecting download link security in step S101 is constantly boosted accordingly.

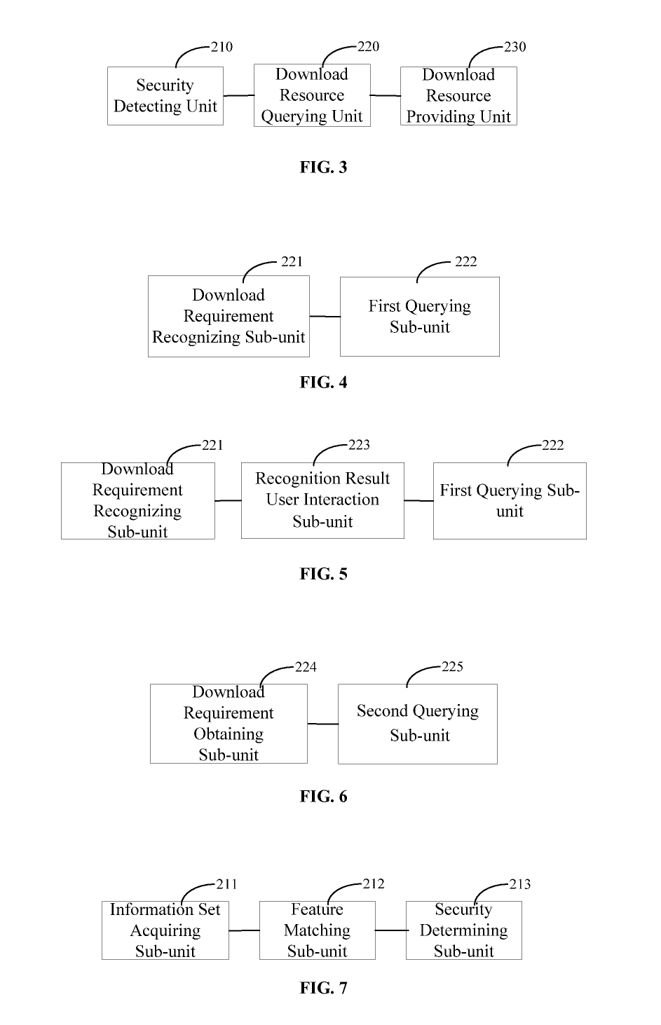

Corresponding to the above method embodiment, the present invention further provides a device for providing download resource. As shown in FIG. 3, the device comprises:
a security detecting unit 210 configured to detect the security of an original resource to be downloaded by a user;
a download resource querying unit 220 configured to query a secure download resource matching the download requirement of the user in the case that a detection result of the security detecting unit is insecure; and
a download resource providing unit 230 configured to provide the user with link information of the secure download resource.

FIG. 4 illustrates a structural schematic view of a download resource querying unit 220 according to the present invention, comprising:
a download requirement recognizing sub-unit 221 configured to recognize the user's download requirement according to the download link information of the original resource; and
a first querying sub-unit 222 configured to query the secure download resource matching with a recognition result.

FIG. 5 illustrates another structural schematic view of the download resource querying unit 220 according to the present invention. On the basis of the structure shown in FIG. 4, the download resource querying unit 220 further comprises a recognition result user interaction sub-unit 223 configured to, after the download requirement recognizing sub-unit recognizes the user's download requirement, present the recognition result to the user and request the user to confirm the recognition result.

In the case that the download resource querying unit 220 comprises the recognition result user interaction sub-unit 223, the first querying sub-unit 222 is specifically used to query the secure download resource matching with the user-confirmed recognition result.

The download requirement recognizing sub-unit 221 shown in FIG. 4 or FIG. 5 is specifically configured to:
obtain a file name of the original resource according to the download link information of the original resource and recognize the user's download requirement by means of the file name;
and/or
obtain a download webpage title of the original resource according to the download link information of the original resource and recognize the user's download requirement by means of the download webpage title;
and/or
recognize the user's download requirement according to presented webpage text information corresponding to the download link of the original resource.

FIG. 6 illustrates another structural schematic view of a download resource querying unit 220 according to the present invention, comprising:
a download requirement obtaining sub-unit 224 configured to obtain the download requirement information input by the user; or obtain the user's download requirement information according to the user's historical search behaviors; and
a second querying sub-unit 225 configured to query the secure download resource matching with content of the download requirement information input by the user.

FIG. 7 illustrates a structural schematic view of a security detecting unit 210 provided by the present invention, comprising:
an information set acquiring sub-unit 211 configured to pre-acquire an information set of download link security; wherein the information set acquiring sub-unit 211 may be specifically used for acquiring the information set of download link security from the network side server, and the acquired information set of download link security may comprise one or more of the following content: download link black list, download link white list, download website black list, and download website white list.
a feature matching sub-unit 212 configured to perform feature matching between the download link information of the original resource and content of the information set; and a security determining sub-unit 213 configured to determine security of the original resource according to a feature matching result.

In an embodiment of the present invention, the feature matching sub-unit 212 may be specifically configured to extract the download link information in the current webpage when the user is browsing the webpage, and perform feature matching between the extracted download link information and the content of the information set.

In another embodiment of the present invention, the feature matching sub-unit 212 may further be configured to perform feature matching between the download link information and the content of the information set when the user triggers the download operation.

According to an embodiment of the present invention, the information set acquiring unit 210 may directly acquire the information set of download link security preset in the local computer, or acquire the information set of download link security from the network side server, and get updated synchronously with the network side at any time. The information set of download link security in the network side server may be obtained in the following manners:

After a client finishes the resource download, security of the downloaded resource is detected and a detection result is reported to the network side server; the network side server generates the information set of download link security according to detection results reported by one or more clients. The clients in the present embodiment correspond to computers installed with conventional anti-virus software, and they are characterized by performing the security detection after downloading data to the local computer. As such clients objectively abound in the Internet, the solution of the present embodiment makes full use of this point, and diverts the testing task originally to be completed by the system side to individual users on the Internet. As such, without increasing human cost on the system side, the content of the information set of download link security can be updated constantly, and a security detecting capability of the security detecting unit 210 can be boosted constantly.

To facilitate description, the above devices are respectively described with various units according to functions. When the present invention is implemented, the functions of the various units may be implemented in a same or a plurality of software and/or hardware.

As known from description of the above embodiments, those skilled in the art can clearly understand that the present invention may be implemented by means of software with necessary universal hardware platforms. Based on such an understanding, the nature of technical solution of the present invention, namely, portions thereof making contribution over the prior art, may be embodied in the form of software product. The computer software product may be stored in storage media, e.g., ROM/RAM, magnetic disk, or optical disc, and includes several instructions to enable a computer equipment (which may be a personal computer, server, network device or the like) to execute the method as described in the embodiments of the present invention or some portions of the embodiments.

Embodiments of the present description all are described in a progressive manner. As to identical or similar portions of individual embodiments, cross-reference may be made to each other. Each embodiment is focused on differences from other embodiments. Particularly, regarding device embodiments, since they are substantially similar to method embodiments, they are described relatively simply, and reference may be made to partial description of the method embodiments at related points. The devices described above are only illustrative, wherein units described as separate members may be or may not be physically separate, members shown as units may be or may not be physical units, i.e., they may be located at one place or may be distributed in a plurality of network units. Partial or all modules therein may be selected according to actual needs to achieve the object of the solution of the present embodiment. Those having ordinary skill in the art may understand and implement these without contributing any inventive work.

Embodiments according to the present invention may be implemented in hardware, or implemented by software modules running on one or more processors, or implemented in their combinations. Those skilled in the art should understand that a microprocessor or digital signal processor (DSP) may be used in practice to implement some or all functions of some or all parts of the device according to embodiments of the present invention. The present invention may also be implemented as an apparatus or device program (e.g., computer program and computer program product) for executing part or all methods described here. Such programs for implementing the present invention may be stored in a computer-readable medium, or may be in a form of having one or more signals. Such signals can be obtained by downloading from the Internet, or provided on a carrier signal or provided in any other forms.

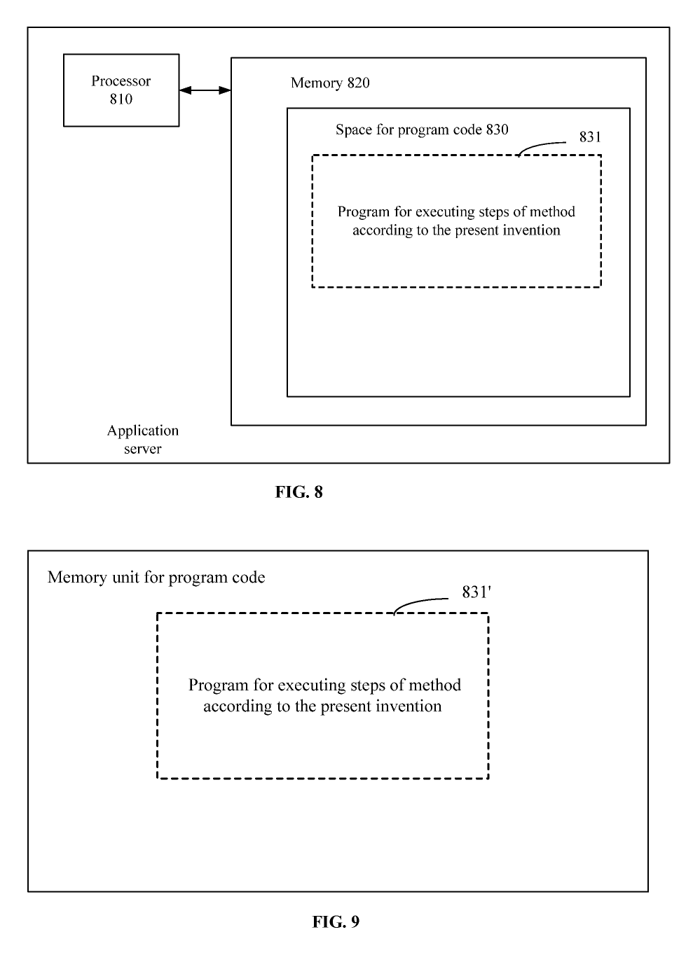

For example, FIG. 8 illustrates a server, such as an application server, which can implement the method according to the present invention. The server conventionally comprises a processor 810 and a computer program product or computer-readable medium in the form of a memory 820. The memory 820 may be an electronic memory such as flash memory, EEPROM (Electrically Erasable Programmable Read—Only Memory), EPROM, hard disk, ROM, or the like. The memory 820 has a storage space 830 for a program code 831 for executing any step of the above method. For example, the storage space 830 for the program code may comprise program codes 831 respectively for implementing steps of the above method. These program codes may be read from one or more computer program products or written into the one or more computer program products. These computer program products comprise program code carriers such as hard disk, compact disk (CD), memory card or floppy disk. Such computer program products are usually portable or fixed memory unit as shown in FIG. 9. The memory unit may have a storage segment, a storage space or the like arranged in a similar way to the memory 820 in the server of FIG. 8. The program code may for example be compressed in a suitable form. Usually, the memory unit includes a computer-readable code 831′, namely, a code readable by a processor for example similar to the processor 810. When these codes are run by the server, the server is caused to execute the steps of the method described above.

Reference herein to “one embodiment”, “an embodiment”, or to “one or more embodiments” means that a particular feature, structure, or characteristic described in connection with the embodiments is included in at least one embodiment of the invention. Further, it is noted that instances of the phrase “in one embodiment” herein are not necessarily all referring to the same embodiment.

The description provided here describes a lot of specific details. However, it is appreciated that embodiments of the present invention may be implemented in the absence of these specific details. In some embodiments, in order to understand the present description without confusions, methods, structures and technologies well known in the art are not specified in detail.

It should be noted that the above embodiments are intended to illustrate but not to limit the present invention, and those skilled in the art may design alternative embodiments without departing from the scope of the appended claims. In claims, any reference signs placed in parentheses should not be construed as limiting the claims. The word “comprising” does not exclude the presence of elements or steps not listed in a claim. The word “a” or “an” preceding an element does not exclude the presence of a plurality of such elements. The present invention may be implemented by virtue of hardware including several different elements and by virtue of a properly-programmed computer. In claims enumerating several units of a device, several of these units can be embodied by one and the same item of hardware. The usage of the words first, second and third, et cetera, does not indicate any ordering. These words are to be interpreted as names.

In addition, it should be noted that the language used in the specification has been principally selected for readability and instructional purposes, and may not have been selected to delineate or circumscribe the inventive subject matter. Therefore, those having ordinary skill in the art appreciate that many modifications and variations without departing from the scope and spirit of the appended claims are obvious. The disclosure of the present invention is intended to be illustrative, but not limiting, of the scope of the invention, which is set forth in the claims.

1. A method for providing download resource comprising:
detecting security of an original resource to be downloaded by a user;
if the original resource is detected to be insecure, querying a secure download resource matching the user's download requirement; and
providing the user with link information of the secure download resource.

2. The method according to claim 1, wherein the querying of the secure download resource matching the user's download requirement comprises:
recognizing the user's download requirement according to a download link information of the original resource;
querying the secure download resource matching with a recognition result.

3. The method according to claim 2, wherein after the recognizing of the user's download requirement, the method further comprises:
presenting the recognition result to the user and requesting the user to confirm the recognition result;
wherein the querying of the secure download resource matching with the recognition result comprises: querying the secure download resource matching with the user-confirmed recognition result.

4. The method according to claim 2, wherein the recognizing of the user's download requirement according to the download link information of the original resource comprises:
obtaining a file name of the original resource according to the download link information of the original resource, and recognizing the user's download requirement by means of the file name;
and/or
obtaining a download webpage title of the original resource according to the download link information of the original resource, and recognizing the user's download requirement by means of the download webpage title;
and/or
recognizing the user's download requirement according to presented webpage text information corresponding to the download link of the original resource.

5. The method according to claim 1, wherein the querying of the secure download resource matching the user's download requirement comprises:
obtaining a download requirement information input by the user, and querying the secure download resource matching with content of the download requirement information input by the user;
and/or
obtaining a download requirement information of the user according to the user's historical search behaviors; and querying the secure download resource matching with content of the download requirement information of the user.

6. The method according to claim 1, wherein the detecting of the security of the original resource to be downloaded by the user comprises:
pre-acquiring an information set of download link security;
performing a feature matching between a download link information of the original resource and content of the information set of download link security; and
determining security of the original resource according to a feature matching result.

7. The method according to claim 6, wherein the feature matching between the download link information of the original resource and the content of the information set comprises:
extracting the download link information from a current webpage when the user is browsing the webpage; and performing the feature matching between the extracted download link information and the content of the information set of download link security;
or
performing the feature matching between the download link information and the content of the information set of download link security when the user triggers a download operation.

8. The method according to claim 6, wherein the information set of download link security comprises one or more of the following lists:
download link black list;
download link white list;
download website black list;
download website white list.

9. The method according to claim 6, wherein the information set of download link security is obtained at least in the following manner:
after a client has downloaded a resource, detecting security of the downloaded resource and reporting a detection result to a network side server;
generating the information set of download link security by the network side server according to the detection results reported from one or more clients;
acquiring the information set of download link security from the network side server.

10. A device for providing download resource comprising:
a security detecting unit configured to detect security of an original resource to be downloaded by a user;
a download resource querying unit configured to query a secure download resource matching the user's download requirement in the case that a detection result of the security detecting unit is insecure; and
a download resource providing unit configured to provide the user with link information of the secure download resource.

11. The device according to claim 10, wherein the download resource querying unit comprises:
a download requirement recognizing sub-unit configured to recognize the user's download requirement according to a download link information of the original resource; and
a first querying sub-unit configured to query the secure download resource matching with a recognition result.

12. The device according to claim 11, wherein the download resource querying unit further comprises:
a recognition result user interaction sub-unit configured to, after the download requirement recognizing sub-unit recognizes the user's download requirement, present the recognition result to the user and request the user to confirm the recognition result;
wherein the first querying sub-unit is specifically configured to query the secure download resource matching with the user-confirmed recognition result.

13. The device according to claim 11, wherein the download requirement recognizing sub-unit is specifically configured to:
obtain a file name of the original resource according to the download link information of the original resource and recognize the user's download requirement by means of the file name;
and/or
obtain a download webpage title of the original resource according to the download link information of the original resource and recognize the user's download requirement by means of the download webpage title;
and/or
recognize the user's download requirement according to presented webpage text information corresponding to the download link of the original resource.

14. The device according to claim 10, wherein the download resource querying unit comprises:
a download requirement obtaining sub-unit configured to obtain a download requirement information input by the user; or obtain the user's download requirement information according to the user's historical search behaviors; and
a second querying sub-unit configured to query the secure download resource matching with content of the download requirement information input by the user.

15. The device according to claim 10, wherein the security detecting unit comprises:
an information set acquiring sub-unit configured to pre-acquire an information set of download link security;
a feature matching sub-unit configured to perform a feature matching between a download link information of the original resource and content of the information set; and
a security determining sub-unit configured to determine security of the original resource according to a feature matching result.

16. The device according to claim 15, wherein the feature matching sub-unit is specifically configured to:
extract the download link information from a current webpage when the user is browsing the webpage; and perform the feature matching for the extracted download link information and the content of the information set;
or
perform the feature matching between the download link information and the content of the information set when the user triggers a download operation.

17. The device according to claim 15, wherein the information set of download link security comprises:
download link black list, download link white list, download website black list and/or download website white list.

18. The device according to claim 15, wherein the information set acquiring sub-unit is specifically configured to acquire the information set of download link security from a network side server, wherein the information set of download link security is acquired at least in the following manner: after a client has downloaded a resource, detecting security of the downloaded resource and reporting a detection result to the network side server; generating the information set of download link security by the network side server according to the detection results reported from one or more clients.

19. (canceled)

20. A computer readable medium which stores a computer program comprising a computer readable code, wherein when the computer readable code is run on a server, the server is caused to execute the method for providing download resource according to claim 1.
